(19) United States
(12) Patent Application Publication
(10) Pub. No.: US 2015/0183886 A1
(43) Pub. Date: Jul. 2, 2015

(54) Process for preparing cellulose ether

(71) Applicant: Akzo Nobel N.V., Arnhem (NL)

(72) Inventor: Björn Mikael Vidmark, Sjalevad (SE)

(21) Appl. No.: 14/657,374

(22) Filed: Mar. 13, 2015

Related U.S. Application Data
(63) Continuation of application No. 12/522,429, filed on Jul. 8, 2009, now abandoned.
(60) Provisional application No. 60/899,762, filed on Feb. 6, 2007.

(30) Foreign Application Priority Data
Jan. 22, 2007 (EP) 07100918.7

(51) Int. Cl. C08B 11/00

(52) U.S. Cl. CPC C08B 11/00

(57) ABSTRACT

The invention relates to a process for preparing a cellulose ether wherein the cellulose ether is prepared in the presence of an ether of the formula R1—O—R2 having a boiling point between 40 and 90° C., or of a solvent mixture comprising an ether and having a boiling point between 40 and 90° C., wherein R1 and R2 may be the same or different and are independently selected from an alkyl group.

The invention relates to a process for preparing cellulose ether.

Processes for preparing cellulose ether are well known in the art. A wide range of solvents or suspending media is used.

For example, in DD 0151 757 the preparation of carboxymethyl cellulose using a solvent mixture comprising 0-5 percent by weight (wt %) pyran, 0-5 wt % dialkyl ether such as dibutyl ether, 80-98 wt % ethanol, and 2-20 wt % water is described.

EP 80678, EP 117490, and U.S. Pat. No. 4,550,161 disclose the preparation of a cellulose ether using dimethoxyethane as an organic solvent. Combinations of dimethoxy ethane and alkanols, alkanediols, and alkoxyalkanols are also mentioned. Reference is made in these documents to the use of many other organic solvents, but the use of specific aliphatic ethers is not mentioned.

U.S. Pat. No. 2,618,635, U.S. Pat. No. 3,652,539, DE 1909140, and U.S. Pat. No. 4,582,899 disclose the preparation of cellulose ethers in the presence of an organic solvent that can be chosen from a group of compounds including dioxane, tetrahydrofuran, and ethylene glycol diethyl ether.

GB 1028724 discloses the preparation of hydroxypropyl cellulose ethers in the presence of propylene oxide. It is mentioned that diisopropyl ether or dibutyl ether may be added as a cosolvent.

U.S. Pat. No. 2,217,904 discloses the preparation of cellulose ether in the presence of benzene at temperatures increasing to up to 150° C. It is said that other inert diluents can also be used. Among these diluents are listed a number of ethers including diethyl ether, dipropyl ether and diisopropyl ether, dibutyl ether and diisobutyl ether, and dibenzyl ether.

Other references such as JP 2000-186101, U.S. Pat. No. 5,395,930, U.S. Pat. No. 6,958,393, and GB 909,039 describe the use of dimethyl ether as solvent in the preparation of cellulose ethers.

DE 542158 and U.S. Pat. No. 3,903,076 disclose the preparation of cellulose ethers in the presence of azeotropes but do not mention azeotropes or solvent mixtures of any specific aliphatic ether with water.

The object of the present invention is to provide an improved process for preparing cellulose ether.

This object is achieved by a process for preparing a cellulose ether wherein the cellulose ether is prepared in the presence of an ether of the formula R1—O—R2 having a boiling point between 40 and 90° C., or of a solvent mixture comprising an ether and having a boiling point between 40 and 90° C., wherein R1 and R2 may be the same or different and are independently selected from an alkyl group.

It should be noted that U.S. Pat. No. 3,218,314 discloses the preparation of substituted polysaccharides in the presence of an inert liquid. However, the specific use of an ether according to the present invention in a process for the preparation of cellulose ethers is neither disclosed nor suggested in this document. Nor are the lower temperature and pressure that can be used applying such ethers as reaction medium in a cellulose ether preparation process suggested by this document.

The invention makes for a simpler and less expensive process than conventional processes. The inventors have surprisingly found that by choosing the ether or azeotrope mixture of the invention, the reaction steps of the process can be conducted at higher temperatures, allowing shorter reaction times and/or lower pressures compared to lower boiling solvents or suspending media, such as diethyl ether. This further allows a less complex reactor suitable for use at the desired temperature and pressure to be employed.

The inventors have further found that the ethers of the process of the invention can be more easily separated from the cellulose ether compared to ethers with a higher boiling point or other solvents known in the art such as alcohols, aldehydes or ketones and, when present, from a second solvent, and in particular from water, compared to the state of the art ethers, such as dimethyl ether and tetrahydrofuran. Easier solvent separation will render the process more economically attractive and will lead to a purer product with no odour of the solvents used in the process.

It should be noted that cellulose ethers are frequently purified by an extraction or washing step with water. Therefore, the ethers used for the preparation process of the invention should not be (too) soluble in water. Preferred ethers are those that are not soluble in an amount of more than 65000 mg per kg of water, more preferably in an amount of not more than 55000 mg per kg of water.

The ether which is suitably used in the process of the invention has a boiling point of between 40 and 90° C. Preferably, the ether has a boiling point of between 40 and 80° C., more preferably between 50 and 75° C.

The process of the invention is preferably performed at a temperature of below 150° C., more preferably at a temperature of below 125° C., most preferably at a temperature of below 100° C. If the process is performed at temperatures above 100° C. or even above 125° C. or above 150° C., the risk of degradation of the cellulose starting material and the cellulose ether product increases and more by-product formation will be found.

The process is preferably performed at a pressure between atmospheric pressure and 8 atmospheres, preferably between 2 and 5 atmospheres, depending on the boiling point of the solvent or solvent mixture used, which should not become too high, as explained above.

Suitable examples of the ethers that can be used in the process of the present invention include ethers wherein R1 and R2 are a linear or branched C₁-C₆ alkyl group. Preferred ethers are those wherein R1 is a methyl or ethyl group and R2 is a secondary or tertiary alkyl group, even more preferably a tertiary alkyl group. Suitable examples of such more preferred ethers are diisopropyl ether, methyl tert-butyl ether, ethyl tert-butyl ether, and methyl tert-amyl ether. In a most preferred embodiment, the ether is selected from the group consisting of methyl tert-butyl ether and ethyl tert-butyl ether.

The solvent mixture of the invention comprises an ether and a second solvent, and the mixture has a boiling point of between 40 and 80° C. In one embodiment of the invention, the solvent mixture is an azeotrope. Preferably, the solvent mixture has a boiling point of at least 45° C., most preferably of at least 50° C., and of at most 75° C., and most preferably of at most 70° C. Suitable ethers include the above-mentioned ethers. The second solvent or suspending medium can be any solvent that will form a solvent mixture in accordance with the invention and/or an azeotrope with the ether in accordance with the invention. Suitable solvents include alcohols such as ethanol, isopropanol or tert-butanol, and water. Preferably, the second solvent is water. Mixtures which besides the ether and the second solvent comprise further solvents are also covered by the present invention.

In the context of the present application, the terms “solvent” and “suspending medium” refer to liquid media in which the cellulose, cellulose ether or any intermediate in the process of the invention dissolves either partially or completely, or suspends and forms a suspension.

The weight ratio between the ether and the second solvent can be from 100:1 to 1:1, preferably from 50:1 to 1:1, and most preferably from 20:1 to 2:1.

The ether, solvent mixture or azeotrope mixture is used in any desirable amount and can be added at any time in the process. The specific choice of conditions lies within the skill of the skilled person.

The cellulose ether of the present invention can be any cellulose ether known in the art. The cellulose ether can be non-ionic and anionic. Examples of non-ionic cellulose ethers are methyl cellulose, hydroxyethyl cellulose, methyl hydroxyethyl cellulose, ethyl hydroxyethyl cellulose, methylethyl hydroxyethyl cellulose, hydroxypropyl hydroxyethyl cellulose, methyl hydroxypropyl hydroxyethyl cellulose, hydroxypropyl cellulose, methyl hydroxypropyl cellulose, and ethyl hydroxypropyl cellulose. Examples of anionic cellulose ethers are carboxymethyl cellulose, hydroxyethyl carboxymethyl cellulose, hydroxypropyl carboxymethyl cellulose, sulfoethyl cellulose, hydroxyethyl sulfoethyl cellulose, and hydroxypropyl sulfoethyl cellulose. Further examples of these cellulose ethers are hydrophobically modified cellulose ethers, which are also known in the art, for example from EP 0 991 668 and EP 1 117 694. Also mixtures of any of the above cellulose ethers can be used in the process of the invention. Preferably, the cellulose ether prepared is a non-ionic cellulose ether.

The processes for preparing the above cellulose ethers are known in the art. For example, such processes are described in “Cellulose ethers” by T. G. Majewicz and T. J. Podlas (in Kirk-Othmer Encyclopedia of Chemical Technology, Vol. 5, pp. 445-466, online posting date: Dec. 4, 2000) and involve, e.g., the reaction of cellulose with an alkyl halogenide or carboxyalkyl halogenide at an elevated temperature.

In a preferred embodiment the process encompasses a ratio of solvent or solvent mixture to charged cellulose of 1:10 to 10:1 by weight.

The invention is illustrated in the following examples.

### EXAMPLES

### Example 1

A reactor was charged with 8,000 units by weight of ground wood pulp, whereupon the gas phase of the reactor was evacuated to 5 kPa and filled with nitrogen to atmospheric pressure. Thereafter 5,067 units by weight of an aqueous alkali solution containing 50% by weight of NaOH were sprayed on the ground pulp under stirring, followed by the addition of 13,600 units by weight of MTBE (methyl tert-butyl ether). The mixture was heated to 75° C. After heating, 4,940 units by weight of propylene oxide were added, followed by a temperature increase to 80° C. Then 1,204 units by weight of methyl chloride were added. A second charge of 5,600 units by weight of an aqueous alkali solution containing 50% by weight of NaOH was sprayed on the reaction mass under stirring, followed by the addition of a further 5,985 units by weight of methyl chloride. The temperature was maintained at 80° C. for 45 minutes to finalize the reaction. After the reaction volatile components including the MTBE were driven off and the rest of the reaction mixture was washed with water at a temperature of >95° C. to remove by-products. The solid phase was separated by centrifugation and dried to a moisture content of less than 3%.

Finally, the cellulose ether was milled to a particle size of less than 1 mm. The cellulose ether was analyzed with regard to the degree of substitution (DS) of methyl and ethyl and the molecular substitution (MS) of hydroxypropyl by gas chromatography after cleavage by hydrobromic acid and hydroiodic acid. The flocculation temperature was determined with the use of a spectrophotometer under a continuous temperature increase. The viscosity was measured by Brookfield viscometer, type LV, at a temperature of 20° C. in a 1% buffered solution at pH 7.0, while the clarity was measured by light transmission in comparison with water at 20° C.

### Comparative Example A

In this Comparative Example the process described in Example 1 was followed, except that iso-propanol was used as solvent instead of MTBE.

The cellulose ethers of Example 1 and Comparative Example A were analyzed. The results are shown in Table 1.

TABLE 1

| | MS | DS | Visc | Clarity | Flocculation | |
|---|---|---|---|---|---|---|
| Example | PO | Me | (mPas) | (%) | Temp (° C.) | Odour |
| 1 | 0.53 | 1.36 | 2,088 | 89 | 55.2 | No odour |
| | | | | | | after |
| | | | | | | washing |
| A | 0.54 | 1.21 | 885 | 80 | 56.6 | Odour of |
| | | | | | | IPA after |
| | | | | | | washing |

1-10. (canceled)

11. A process for preparing a cellulose ether comprising the reaction of cellulose with an alkyl halogenide or carboxyalkyl halogenide at an elevated temperature wherein the cellulose ether is prepared in the presence of an ether of the formula R1—O—R2 having a boiling point between 40 and 90° C., or of a solvent mixture comprising an ether and having a boiling point between 40 and 90° C., wherein R1 is a methyl or ethyl group and R2 is a secondary or tertiary alkyl group.

12. A process according to claim 11 wherein the ether has a boiling point of between 50 and 75° C.

13. A process according to claim 11 wherein the ether has a solubility in water of not more than 55000 mg per kg of water.

14. A process according to claim 11 wherein R2 is a tertiary alkyl group.

15. A process according to claim 11 wherein the ether is selected from the group consisting of ethyl tert-butyl ether, methyl tert-butyl ether, and ethyl tert-amyl ether.

16. A process according to claim 15 wherein the ether is selected from the group consisting of ethyl tert-butyl ether and methyl tert-butyl ether.

17. A process according to claim 11 wherein the solvent mixture is an azeotrope.

18. A process according to claim 17 wherein the solvent mixture comprises an ether and water.

19. A process according to claim 18 wherein the ether is selected from the group consisting of ethyl tert-butyl ether, methyl tert-butyl ether, and methyl tert-amyl ether.

20. A process according to claim 19 wherein the ether is selected from the group consisting of ethyl tert-butyl ether and methyl tert-butyl ether.

21. A process according to claim 11 wherein the cellulose ether is a non-ionic cellulose ether selected from the group consisting of methyl cellulose, hydroxyethyl cellulose, methyl hydroxyethyl cellulose, ethyl hydroxyethyl cellulose, methylethyl hydroxyethyl cellulose, hydroxypropyl hydroxyethyl cellulose, methyl hydroxypropyl hydroxyethyl cellulose, hydroxypropyl cellulose, methyl hydroxypropyl cellulose, and ethyl hydroxypropyl cellulose.

22. A process according to claim 11 wherein the process is carried out at a temperature of below 150° C.
